(19) United States
(12) Patent Application Publication
(10) Pub. No.: US 2012/0078428 A1
(43) Pub. Date: Mar. 29, 2012

(54) SMART METERING DEVICE WITH PHASE SELECTOR

(75) Inventor: Luc Henderieckx, Kontich (BE)

(73) Assignee: EANDIS, Melle (BE)

(21) Appl. No.: 13/148,423

(22) PCT Filed: Feb. 8, 2010
(86) PCT No.: PCT/EP2010/051511

§ 371 Date: Dec. 13, 2011

(30) Foreign Application Priority Data
Feb. 6, 2009 (EP) 09152287.0

(51) Int. Cl. G05F 5/02; G06F 1/28; G05B 15/02

(52) U.S. Cl. 700/292; 700/297

(57) ABSTRACT

Smart metering device for connecting an end user mains network to a multiple phase power distribution network and monitoring consumption on the end user mains network, comprising: inputs for connecting the smart metering device to multiple phases of the multiple phase power distribution network; single phase low voltage outputs for connecting the end user mains network to the smart metering device; a power circuit between the inputs and the low voltage outputs; a modem for receiving control messages sent from a communication server associated with the power distribution network; a controller communicatively connected to the modem for controlling switching operations in the smart metering device in response to the control messages; and a phase selector communicatively coupled with the controller and comprising input switches for switching the low voltage outputs between different sets of the inputs, each set corresponding to one of the multiple phases of the multiple phase power distribution network.

### TECHNICAL FIELD

The present invention relates to a smart metering device according to the preamble of claim 1 and a method for managing load on a multiphase power distribution network using such a smart metering device.

### BACKGROUND ART

In the coming years, utility companies, in casu those that operate distribution networks for electricity, will start replacing most or all of their electromechanical Ferraris meters by so called “smart meters” that can be read remotely. Several ways to communicate with those meters exist, but one in particular is ideally suited for the task, namely Power Line Communication or PLC. It offers two major advantages: it is in the hands of the LV network operators themselves and it is a means to get “plug and play” operation as the meter is automatically connected to the communication platform as the meter is branched to the low voltage network.

Using PLC, the power distributor can remotely switch off parts of the connected end user mains networks, for example parts which only need power at night.

EP-A-2009807 describes examples of power line communication system and smart metering devices therefore.

From U.S. Pat. No. 6,018,203 an apparatus for load distribution across a multiphase power network is known. This apparatus has the disadvantage of switching under possibly heavy load conditions.

### DISCLOSURE OF THE INVENTION

It is an aim of this invention to provide a smart metering device with which the power distributor can manage the distribution of the load on the phases of the power distribution network and perform phase switching operations under no load conditions.

This aim is achieved with the smart metering device showing the technical characteristics of claim 1.

According to the invention, the smart metering device is provided with a phase selector by means of which the outputs can be switched from one phase to another. In this way, when a plurality of end user mains networks are connected to one power distribution network part by means of the smart metering device of the invention, the power distributor can remotely control the phase selectors at the different end user mains networks to redistribute the load over the different phases of the distribution network. Hence, a more even spreading of the load can be achieved.

According to the invention, the smart metering device is provided with output switches under control of the controller, by means of which the various parts of the end user mains network can be switched off. These output switches are opened before operating the phase selector to switch the end user network to a different phase. In this way, the switching of the phase can be done under no load conditions. The metering device can detect the zero current condition with it's built in metering circuits to make sure that the phase selector only switches under no load. Since the phase selector only switches under no load conditions, the input switches can be optimised for low contact resistance, so that substantially no wear of the contacts of the input switches is caused and a long life of the phase selector can be ensured. The output switches are closed again shortly after the phase has been switched. The whole operation means only a brief interruption of the power on the end user mains network, which is no problem for any appliances connected to the end user mains network.

Beside the possibility to switch the phases of certain meters on a given network based on load imbalance, switching can also be decided based on the phase voltages (typically at the end of the LV-cables or -lines) falling outside minimum and maximum limits. A smart meter equipped with a phase selector can be configured to connect to the phase with the highest voltage at the moment of the initial installation. The central server can also instruct certain meters to switch to the phase with the best power quality (p.ex. highest voltage on that phase). In case one phase is switched off because of a protection fuse acting, a meter can be provided for switching to one of the phases still carrying a normal voltage level. This can be achieved locally, by appropriate steps in the algorithm of the controller, or remotely by control messages from the server.

The phase switching operation is preferably performed when the power consumption is low, for example during the night. In preferred embodiments, the power consumption is monitored in the smart metering device by means of the built in metering circuits to detect when the power consumption drops below a predetermined level and any phase switching operation is performed only then, so as to limit the impact on the customer or appliances. The smart metering device can communicate with the central meter management server so as to send power consumption and status information to the server, which can thereupon send back control messages and/or parameters for establishing the phase switching operations. The predetermined power consumption level can be configurable, i.e. set by the management system.

The phase selectors can be controlled individually or in groups by means of appropriate control signals. These can be sent to the communication modems of the smart metering devices via any known communication network, such as for example internet over landline networks such as coaxial cable, telephone line or other, or wireless networks such as 3G, GPRS or other.

In a preferred embodiment, the communication modem of the smart metering device is provided for PLC communication, so that the power distribution network itself can be used for the control messages and the need for a separate network can be avoided.

In a preferred embodiment, in a network comprising multiple smart metering devices according to the invention, one or more of the smart metering devices has a communication modem provided for PLC communication and functions as a gateway to the other, non-gateway smart metering devices. This means that the communication between the PLC server and the non-gateway smart metering devices occurs via one of the gateway smart metering devices. This solution is extremely convenient when for example the internet, a telephone line, or any other telecommunication network present at the end user installation can be used for the communication between the gateway and the PLC server. The telecommunication network may also be any wireless telecommunication network known to the person skilled in the art. In case multiple gateways are present, the gateway function can be transferred from the one to the other when necessary.

### BRIEF DESCRIPTION OF THE DRAWINGS

The invention will be further elucidated by means of the following description and the appended drawings.

FIG. 1 shows a block diagram of a smart metering device according to the invention.

FIG. 2 shows a preferred embodiment of the phase selector and associated operation table of a smart metering device according to the invention.

FIG. 3 shows possible circuits for use as output switching means in smart metering devices according to an aspect of the invention.

### MODES FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

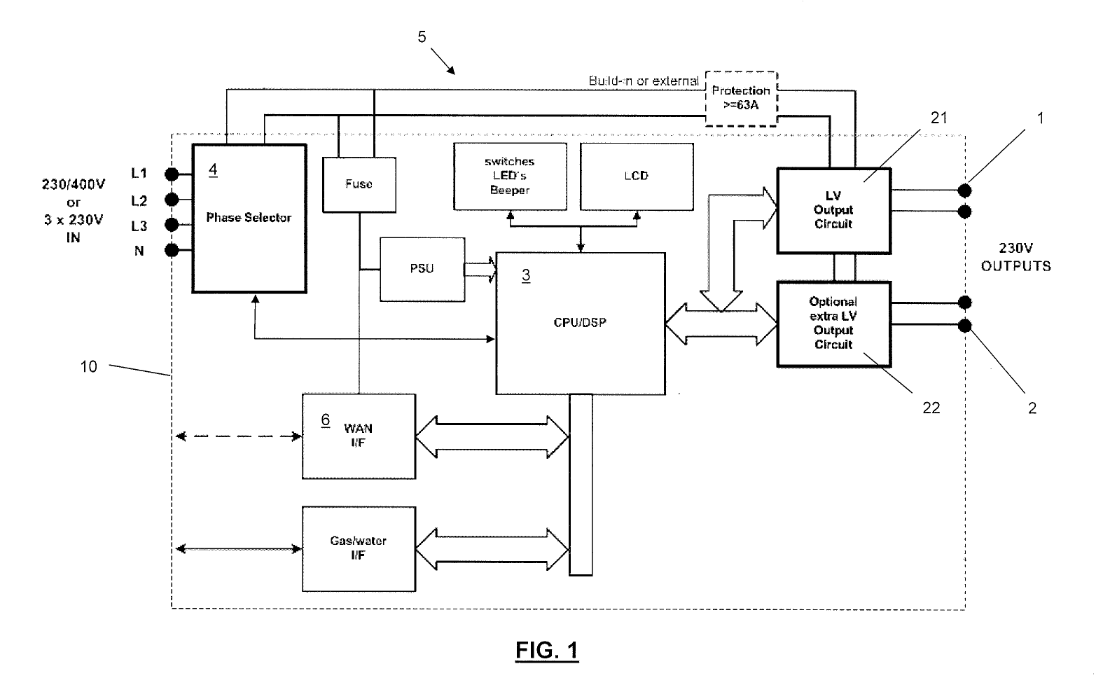

FIG. 1 shows an embodiment of a smart metering device according to the invention. It comprises voltage inputs L1, L2, L3 for connection to a three-phase distribution network, low voltage (LV) output circuits 21, 22 towards the end user mains network, a (built-in or external) power circuit 5 connecting the inputs and outputs, a modem “WAN I/F” 6 for sending and receiving messages over the power distribution network and/or over other networks, a controller “CPU/DSP” 3 for controlling switching operations in response to control messages which can be received over for example the power distribution network from a communication server/centre associated with the power distribution network, and a phase selector 4 at the inputs by means of which the outputs can be switched to different phases of the distribution network in response to received control messages.

Further features of the smart metering device of FIG. 1 are described in EP-A-2009807, which is incorporated herein by reference in its entirety.

Power line communication (PLC) is a known technique to transmit control messages to smart meters. It uses a predefined frequency band (e.g. Cenelec band A or other known bands) well outside the mains frequency.

Smart electricity meters are generally used to control loads by switching their LV-outputs on or off. The two output blocks 21, 22 in FIG. 1 are both performing functions in the LV power circuits of smart meters and enable extra functionality to be implemented that help to improve network-operation and -utilization.

In most LV networks 3 phases are distributed, either with or without neutral conductor. Most customers are connected only to one phase of these three, while many have the 3-phases available on their connection cable. Many networks have severely unbalanced phases which means that the LV-transformers and/or the network cables are unevenly loaded causing excessive heating and larger than necessary voltage drops. Having the possibility to remotely or automatically balance the load on the three phases, as is enabled with the smart metering device of FIG. 1, has several benefits: better power handling of the transformers and cables, lower power losses and voltage drops so that power quality may be increased. This is accomplished by adding the phase selector 4 at the input of the mono-phase smart electricity meter of FIG. 1.

The smart meter has the ability to switch off the load of the customer on its output(s) which allows the phase selection operation to be done under no-load conditions. This makes it possible to utilize simpler and less costly relays or combination of relays to perform the phase switching. Intelligence can be built in so that the smart meters wait to perform the phase switching until the power usage of the customer drops below a certain level, so as to minimize the effects of the short power interruption. Phase switching may be restricted to certain periods of the day, for instance in the middle of the night, to further decrease the eventual disturbance for the inhabitants.

Using smart metering devices according to the invention, load imbalance or too low voltages in LV-cables can be detected on the central system based on load calculations using the individual load profiles determined on the power distribution network part under consideration and the minimum voltages detected on individual smart meters on that network part. Phase switching of a group of end users can subsequently be performed to compensate for the load imbalance or raise the voltage level in the phase where it is too low.

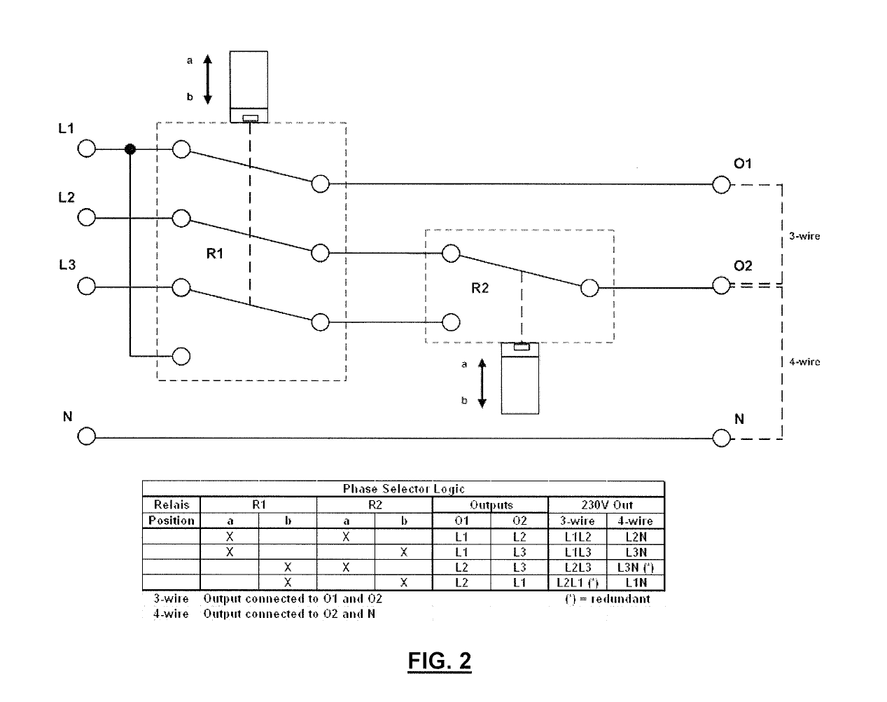

FIG. 2 shows a preferred embodiment of the phase selector 4, with two relays R1, R2 to switch the phase, in particular one triple pole switchover relay R1 followed by one single pole switchover relay R2. The following operation table explains how the different positions of the relays relate to the different phases appearing on the output side O1-O2.

Operation table
Phase Selector Logic

| Relais | R1 | | R2 | | Outputs | | 230 V Out | |
|---|---|---|---|---|---|---|---|---|
| Position | a | b | a | b | O1 | O2 | 3-wire | 4-wire |
| | x | | x | | L1 | L2 | L1L2 | L2N |
| | x | | | x | L1 | L3 | L1L3 | L3N |
| | | x | x | | L2 | L3 | L2L3 | L3N (*) |
| | | x | | x | L2 | L1 | L2L1 (*) | L1N |

3-wire Output connected to O1 and O2
4-wire Output connected to O2 and N
(*) = redundant

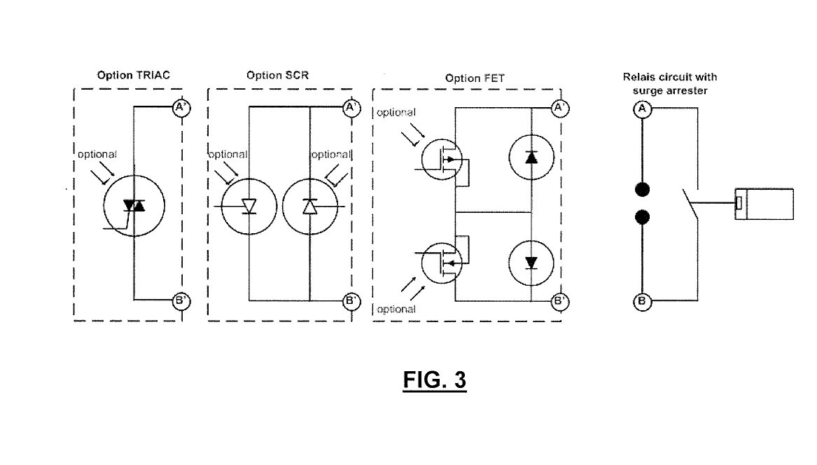

In another aspect of smart metering devices according to the invention, which may or may not be combined with the aspects described above, the output switching means comprise power relays with parallel semiconductor switches. Possible structures are shown in FIG. 3. One of the three options (TRIAC, SCR or FET) is put in parallel to the relay's contacts by interconnecting A with A′ and B with B′. The semiconductors may be either electrically or optically controlled. The semiconductors are presented symbolically without peripheral components.

Smart meters are generally equipped with a power relay at the output(s) so as to be able to remotely switch off customers. This relay has to be able to sustain multiple switching operations, often under heavy load, sometimes repeatedly, which may cause overheating and heavy wear on the switches' contacts. This is remedied in this aspect of the smart metering devices by performing the switching action by means of some kind of semiconductor switch, which has almost no wear when switching as long as it is operated under its maximum ratings. Semiconductor switches can in fact be far more reliable than relays in this respect. Disadvantage of this is however that some power is dissipated in the semiconductors causing them to heat up which also has to be considered as a power loss. Using both types of switches in parallel resolves both problems when the proper switching sequence is used. The relay contacts can in this configuration be optimized for very low contact resistance, and the contact's opening distance can be reduced as no spark extinction mechanisms have to be implemented. They can be of lower cost than relays capable of interrupting the high currents that can be fairly inductive at times, which, at least partly, compensates for the extra cost of the power semiconductors.

An added benefit from using semiconductor switches in parallel to the relay's contacts in case of a smart metering device is that the semiconductor switch offers the possibility to act as a power modulator that allows the network operator to modulate for instance the public lighting or to switch on the customer's load gradually when re-powering after a switch off so as to avoid high inrush currents or hard switch-on on short circuits in case of an incident.

When the meter is used as a modulator for public lighting, care should be taken to avoid overheating of the power semiconductors in the meters. For this, care should be taken in providing enough cooling capacity for these semiconductors and the temperature of them should be monitored to safely switch off the load in case of danger of overheating. The semiconductors used should also have low on resistance so as to limit the power dissipated in the junctions.

As semiconductors TRIAC's, Thyristors or power FET's (both mounted in an anti-parallel or series configuration and protected by diodes against reverse voltages) are suitable. TRIAC's and thyristors offer the advantage of automatic zero current interruption while power FET's may offer lower power losses under load.

Smart meters contain the necessary intelligence to assure that the proper switching sequence is used and safety of the operation is assured. As an example: the best moment to switch on or off a load depends on the type of load: a mainly resistive load can be best switched on or off at zero voltage crossing while an inductive load is best switched on or off at voltage maximum as the current is then generally near its minimum. As a smart meter digitizes both voltage and current the best switch off moment can always be selected based on the currents and voltages. The best switch on moment could be based on the most recent information when this is recent enough or at voltage zero if no valid recent information is available. In any case soft switch on by gradually increasing the opening angle of the semiconductor switches is preferable as this avoids excessive currents at any load. TRIAC's or thyristors always switch off near zero current which is ideal for mostly resistive loads but not very good for inductive loads which may cause even over voltages to be generated. To protect the semiconductors against these over voltages a surge limiter can be installed in parallel to these semiconductors.

As there is always a possibility of leakage currents, failed semiconductor junctions and even remote switch-on commands, the opening of these output circuits may never be considered safe. If a safe interruption of the mains voltages is needed, an extra manually operated switch can be added between the LV-connection and the building installation.

1. Smart metering device for connecting an end user mains network to a multiple phase power distribution network and monitoring consumption on the end user mains network, comprising:
inputs for connecting the smart metering device to multiple phases of the multiple phase power distribution network;
single phase low voltage outputs for connecting the end user mains network to the smart metering device;
a power circuit between the inputs and the low voltage outputs, the power circuit comprising a phase selector comprising input switches for switching the low voltage outputs between different sets of the inputs, each set corresponding to one of the multiple phases of the multiple phase power distribution network;
a modem for receiving control messages sent from a communication server associated with the power distribution network;
a controller communicatively coupled to the modem and the phase selector for controlling switching operations in the smart metering device in response to the control messages;
characterised in that
each single phase low voltage output has an output switch, communicatively coupled with the controller for switching off a part of the end user mains network which is connected to the respective single phase low voltage output;
the controller is adapted—upon receipt of an appropriate control message to operate the phase selector—for operating the output switches to switch off said parts of the end user mains network before operating the phase selector.

2. Smart metering device according to claim 1, characterised in that the input switches of the phase selector are one triple pole switchover relay followed by one single pole switchover relay.

3. Smart metering device according to claim 1, characterised in that the controller is provided with means for comparing the power consumption on the end user mains network with a predetermined level and means for postponing switching of the phase selector until the power consumption drops below the predetermined level.

4. Smart metering device according to claim 1, characterised in that the modem is connected to the power circuit and is provided for power line communication with the communication server over the power distribution network.

5. Smart metering device according to claim 4, characterised in that the modem comprises a gateway for receiving control messages addressed to other smart metering devices via another communication network and passing on these control messages to the other smart metering devices via the power distribution network.

6. Smart metering device according to claim 1, characterised in that the output switches comprise a relay in parallel with a semiconductor switching circuit.

7. Smart metering device according to claim 6, characterised in that the semiconductor switching circuit comprises a TRIAC.

8. Smart metering device according to claim 6, characterised in that the semiconductor switching circuit comprises SCRs.

9. Smart metering device according to claim 6, characterised in that the semiconductor switching circuit comprises FETs.

10. Method for managing the load on multiple phases of a multiple phase power distribution network to which a plurality of end user mains networks are connected via a smart metering device according to claim 1, characterised in that the method comprises the steps of detecting a higher load on one of the phases with respect to an other of the phases and transmitting control messages over the power distribution network to operate the phase selectors of at least some of the smart metering devices to switch the connected end user mains network from the one phase to the other phase, wherein the phase selectors are operated after opening the output switches of the respective smart metering device.

11. Method according to claim 10, characterised in that operation of the phase selectors is restricted to certain periods of the day.

12. Method according to claim 10, characterised in that the method comprises the step of detecting load imbalance between the phases using individual load profiles established by means of the smart metering devices and minimum voltages detected on the smart metering devices.

13. Method according to claim 10, characterised in that the method comprises the step of comparing the power consumption on the end user mains network with a predetermined level and postponing switching of the phase selector until the power consumption drops below the predetermined level.

14. Method according to claim 10, characterised in that the method comprises the steps of monitoring a voltage level on each of the phases of the multiple phase power distribution network and upon phase switching, switching to the phase having the highest voltage level.

15. Method according to claim 10, characterised in that the method comprises the steps of monitoring power failure on each of the phase of the multiple phase power distribution network and upon occurrence of power failure on one of the phases, operating the phase selectors of the smart metering devices connected to the failed phase to another of the phases.
